(19) United States
(12) Patent Application Publication
(10) Pub. No.: US 2026/0349866 A1
(43) Pub. Date: Nov. 5, 2026

(54) System and Method for Compile-Time Generation of Structurally Non-Reconstructible Telemetry for GPU System Diagnostics

(71) Applicants: Gangsuo Zhi, Scarborough (CA); Xiaoyu LEI, Scarborough (CA)

(72) Inventors: Gangsuo Zhi, Scarborough (CA); Xiaoyu LEI, Scarborough (CA)

(21) Appl. No.: 19/198,274

(22) Filed: May 5, 2025

(51) Int. Cl. G06F 11/07; G06F 11/22; G06F 11/263; G06F 11/30; G06F 11/34

(52) U.S. Cl. CPC G06F 11/079; G06F 11/0721; G06F 11/2268; G06F 11/263; G06F 11/30; G06F 11/34

(57) ABSTRACT

A system and method are disclosed for generating fixed-format, structurally non-reconstructible telemetry for GPU diagnostics in bandwidth-constrained, black-box environments. The system statically abstracts graphics API calls at compile time to produce deterministic, asset-free summaries that exclude all fidelity-bearing fields such as shaders, vertex data, or textures. The resulting telemetry supports multi-layer bottleneck attribution while eliminating the need for replay, source access, or developer intervention.

### 1. BACKGROUND OF THE INVENTION

### 1.1 Limitations of Existing Profiling Tools

Existing GPU profiling tools such as RenderDoc, NVIDIA Nsight, AMD RGP, and Intel GPA are primarily designed for developer-facing environments. These tools rely on a capture-replay-inspect paradigm in which a complete set of rendering commands, assets, and GPU states are captured from a live system, then replayed offline for performance or correctness analysis.

To support visual fidelity and frame-level reconstruction, such tools typically record the following types of data:
Vertex buffers and mesh indices;
Shader binaries and pipeline state objects;
Texture memory, framebuffer content, and memory handles;
Command buffer sequences and synchronization primitives.

While such profiling tools are effective during development and debugging, they exhibit several structural limitations when applied in production or black-box environments:
They require high-bandwidth telemetry, often exceeding 100 megabytes per second;
They assume access to rendering assets, shaders, and source-level debugging interfaces;
Their behavior is controlled via runtime scripting, GUI toggles, or configuration profiles.

These characteristics make them unsuitable for deployment in embedded, mobile, automotive, and edge platforms where access to internal rendering logic is restricted or entirely unavailable.

1.2 Problems with Fidelity-Preserving Telemetry

Many existing profilers attempt to reduce telemetry size by filtering or compressing rendering data. However, their underlying telemetry formats remain fidelity-preserving—that is, they retain data fields that can be used to partially or fully reconstruct visual content, shader logic, or scene structure. Examples of such reconstructible fields include:
Memory addresses and buffer object handles;
Shader program identifiers or traces;
Compressed texture data and format metadata;
GPU state descriptors and command stream order.

Telemetry formats that retain such information introduce several operational challenges:
They may violate privacy or confidentiality constraints in regulated industries;
They are incompatible with black-box systems that prohibit developer access or asset inspection;
They require developer involvement to interpret results, typically through visual replay.

Therefore, compression or filtering alone-when applied to fidelity-preserving formats-cannot produce telemetry that is structurally irreversible or inherently non-reconstructible.

### 1.3 Structurally Irreversible and Static Filtering as a Technical Requirement: Eliminating Reconstructibility at the Data Model Level

To enable secure, autonomous, and deployable GPU diagnostics, a new telemetry model is required-one that is structurally irreversible and free from runtime configurability.

Such a system must:
Emit fixed-format summaries that contain no reconstructible fields;
Eliminate memory references, shader links, and visual content from all telemetry outputs;
Rely entirely on compile-time logic to define its filtering and abstraction behavior;
Prohibit runtime scripting, configuration toggles, and user intervention.

For example, a single vertex typically consists of three 32-bit floating-point coordinates (X, Y, Z), totaling 12 bytes. A single draw call may reference anywhere from 2 vertices (a line) to over 100,000 vertices (a complex mesh), depending on GPU capability. Even assuming an optimistic compression ratio of 100:1, the resulting telemetry for 100,000 vertices would still exceed 12,000 bytes. In contrast, the present invention summarizes all draw calls-regardless of vertex count-into just three fixed integers: mesh count, vertex count, and topology type. This design not only eliminates over 99.9% of raw telemetry size but also ensures irreversibility: no combination of deterministic, statistical, or learned techniques can reconstruct vertex data from aggregate scalar summaries.

This is not a trivial compression method, but a structural replacement of data-bearing fields with non-recoverable abstractions. The result is not a lossy representation of the original, but a fundamentally different representation that prohibits reconstruction by design.

These summaries must be statically defined during system build and must not support any form of reverse reconstruction, parameter reconfiguration, or interactive replay.

This structural shift enables diagnostics that are compatible with production environments, privacy constraints, and bandwidth-limited systems-without requiring developer access, visual fidelity, or source code availability.

### 2. SUMMARY OF THE INVENTION

The present invention discloses a system and method for generating telemetry data from graphics applications in a format that is structurally non-reconstructible and produced entirely at compile time, thereby enabling a new class of GPU diagnostic systems that are deployable in bandwidth-constrained and black-box environments without requiring replay, asset access, or developer interaction. The system transforms low-level graphics API activity-such as draw calls and texture bindings-into fixed-format summaries that exclude all fields necessary for visual reconstruction, asset identification, or shader analysis.

Unlike traditional profiling tools that capture fidelity-preserving data for replay or visual inspection, this invention performs irreversible structural abstraction of rendering operations as part of a compile-time integrated telemetry pipeline, producing machine-verifiable summaries that support real-time system diagnostics on embedded and production devices. The filtering and formatting logic is embedded at build time, eliminating the need for runtime scripting, configuration, or asset access.

The system comprises three primary components:
1. Telemetry Adapter
   A data collection module that intercepts graphics API calls and extracts only structural metadata such as vertex count, topology, and texture binding parameters. This adapter excludes any access to shaders, asset content, or memory handles.
2. Compile-Time Filtering Engine
   A statically embedded module that transforms intercepted API calls into fixed-format summaries using logic compiled during system build. This engine performs deterministic abstraction using predefined templates, without allowing runtime modification or user control.
3. Telemetry Output Formatter
   A serialization module that emits telemetry summaries in compact, machine-readable formats suitable for downstream processing. The output includes no reconstructible fields and conforms to a layout that is fixed and verifiable at compile time.

Two fixed-format telemetry structures are defined:
Diagnostic Triplet (per draw call):
   Total mesh count (unsigned integer)
   Total vertex count (unsigned integer)
   Topology descriptor (enumerated value)
Texture Metadata Summary (per binding):
   Resolution (width×height)
   Format identifier (e.g., RGBA8, ASTC)
   Mipmap level count
   Texture type (e.g., 2D, Cubemap)

These summaries contain no pixel data, memory pointers, asset identifiers, or shader code, and cannot be reversed into original rendering data under any mathematical model.

The invention is suitable for use in black-box, embedded, mobile, or OTA environments where replay capability, rendering asset access, and developer interaction are unavailable or undesired. This compile-time structural abstraction reduces telemetry bandwidth consumption by more than 98% compared to fidelity-preserving profilers. It eliminates the need for high-volume telemetry buffers, runtime frame capture modules, and replay-based developer workflows-components which are infeasible to deploy in mobile, automotive, or edge environments. As a result, the system enables the deployment of real-time GPU diagnostics and performance attribution in production black-box systems for the first time, without requiring source code, shader access, or visual inspection.

Unlike runtime-configurable telemetry tools that attempt to reduce bandwidth through optional filters or field-level suppression, the present invention introduces a compile-time-only telemetry architecture whose abstraction logic, data structures, and output format are entirely fixed at build time and structurally irreversible by design. This architectural model cannot be derived through reconfiguration or reduction of any known fidelity-preserving profiler. Conventional tools-such as RenderDoc, Nsight, or RGP-retain asset-referential fields and support visual reconstruction through runtime customization. Therefore, the present invention represents a categorical departure from existing telemetry paradigms, enabling real-time GPU diagnostics in black-box systems that prohibit runtime hooks, asset access, or developer interaction.

Unlike prior tools whose configurability introduces diagnostic variability, the present system offers telemetry determinism across deployments and platforms

### 3. BRIEF DESCRIPTION OF THE DRAWINGS

The following figures illustrate the architecture, telemetry formats, and structural distinctions described in this disclosure. All diagrams are schematic and are intended solely to clarify the technical components and data flow of the present invention. They do not imply any graphical interface, user interaction, or visual replay capability.

FIG. 1—Compile-Time Telemetry Abstraction Pipeline

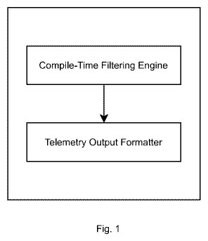

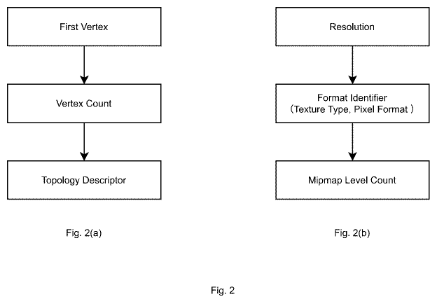

A block diagram illustrating the system architecture.

The pipeline consists of the following modules:
Telemetry Adapter: Intercepts draw calls and texture bindings from graphics API activity, extracting structural metadata only.
Compile-Time Filtering Engine: Applies statically embedded logic to generate fixed-format summaries based on the extracted parameters.
Telemetry Output Formatter: Serializes the summaries into compact, machine-readable records that exclude reconstructible fields.

No runtime configuration, developer control, or fidelity-preserving capture is included in the pipeline. This architecture supports always-on deployment in black-box or bandwidth-constrained environments.

FIG. 2—Fixed-Format Telemetry Structures

A structural diagram illustrating the two summary formats used by the system:

FIG. 2(a): Diagnostic Triplet Format
Each draw call is represented by:
   mesh count (uint32)
   vertex count (uint32)
   topology descriptor (enum8)
No mesh indices, layout descriptors, or asset references are included.

FIG. 2(b): Texture Metadata Summary Format
Each texture binding is summarized by:
   resolution (e.g., 1024×1024)
   format identifier (e.g., RGBA8, ASTC)
   mipmap level count
   texture type (e.g., 2D, Cubemap)
No pixel data, memory addresses, or shader bindings are retained.

### 4. DETAILED DESCRIPTION OF THE EMBODIMENT

### 4.1 System Overview

The disclosed system performs structural telemetry generation through a compile-time-embedded pipeline that converts rendering operations into fixed-format summaries. The system does not rely on runtime logic, replay interfaces, or developer interaction.

The architecture comprises three sequential modules:
A Telemetry Adapter, which intercepts graphics API calls and extracts structural parameters;
A Compile-Time Filtering Engine, which generates abstract summaries of rendering activity;
A Telemetry Output Formatter, which serializes and emits the summaries in a non-reconstructible format.

The system operates continuously from application startup to shutdown without requiring configuration, scripting, or external control.

This system does not permit post-deployment alteration of telemetry logic, thus forming a runtime-sealed architecture in which all telemetry abstraction logic is embedded at compile time and remains immutable throughout the deployment lifecycle.

### 4.2 Telemetry Adapter

The telemetry adapter captures draw-level and texture-level metadata by intercepting graphics API calls. Supported APIs may include Vulkan, OpenGL, OpenGL ES, and DirectX.

The adapter extracts only structural parameters, such as:
Vertex count and instance count;
Primitive topology type (e.g., triangle list, line strip);
Texture resolution, format, and binding location.
   It explicitly avoids accessing or recording:
Vertex buffer content or index data;
Shader binaries or reflection metadata;
Texture memory, pixel values, or memory addresses;
GPU state descriptors, layout bindings, or pipeline objects.

The adapter is implemented via static linking, dynamic preloading (e.g., LD_PRELOAD), or API-level interception (e.g., Vulkan layers). It emits telemetry records in a standard internal format, which are passed directly to the compile-time filtering engine.

This module does not permit post-deployment alteration of telemetry logic.

### 4.3 Compile-Time Filtering Engine

The compile-time filtering engine transforms raw API-derived telemetry into abstracted summaries using statically embedded logic. No runtime rule evaluation, toggling, or script execution is permitted.

The engine may be implemented using predefined compile-time templates, such as macro-generated code builders.

Each draw call is abstracted into a Diagnostic Triplet with the following structure:
mesh_count: total mesh instances rendered (32-bit unsigned integer);
vertex_count: total vertices submitted (32-bit unsigned integer);
topology_type: primitive descriptor (e.g., triangle list) as an 8-bit enumerated value.
   Each texture binding is abstracted into a Texture Metadata Summary:
resolution: width×height (in pixels);
format_id: compact format descriptor (e.g., RGBA8, ASTC);
mipmap_levels: number of levels defined;
texture_type: binding target (e.g., 2D, 3D, Cubemap).

These summaries contain no mesh indices, shader references, texture data, or memory addresses. For example, the telemetry engine emits a Diagnostic Triplet such as:

```
struct DiagnosticTriplet {
  uint32_t mesh_count;
  uint32_t vertex_count;
  uint8_t topology_type;
};
```

Even if the submitted draw call contains tens of thousands of vertices, the abstraction engine discards all floating-point coordinate data and stores only these three integers. From a data entropy and information theory perspective, this operation is irreversible. No algorithm—compression-based or inference-based—can regenerate the lost geometry from such a fixed-length record.

These templates are expanded at compile time to produce static, fixed-size summaries per draw call. No dynamic data structures, variable-length fields, or runtime configuration mechanisms are involved.

The same logic is embedded consistently across all deployments and is not extensible or overrideable at runtime.

This module does not permit post-deployment alteration of telemetry logic.

### 4.4 Telemetry Output Formatter

The output formatter serializes the abstracted telemetry records and emits them in a compact, machine-readable format. Examples include:
JSON (for human-readable logs or CI integration);
Binary stream formats (for embedded platforms);
Protocol Buffers or custom binary packets (for bandwidth-constrained transport).

No visual preview, replay hook, or developer interface is provided. The telemetry is designed to be consumed by downstream automated diagnostics, if desired, but can be stored or transmitted independently.

The telemetry output contains no reconstructible content. Even with full access to emitted records, no geometry, textures, shader behavior, or rendering sequence can be inferred or regenerated.

This module does not permit post-deployment alteration of telemetry logic.

### 4.5 Structural Guarantees of Irreversibility and Non-Reconstructibility

The telemetry summaries produced by the disclosed system are structurally non-reconstructible by design. This irreversibility is not based on encryption, compression, or obfuscation, but on the complete elimination of content-bearing fields at the point of abstraction. All telemetry records are defined at compile time to include only invariant, structural metrics that have no reversible mapping to rendering content or execution behavior.

For example, if a draw call submits 10000 vertices to the graphics pipeline, the emitted telemetry record retains only the scalar value vertex_count=10000. No positional data, normals, texture coordinates, or vertex indices are captured, stored, or referenced. As a result, it is mathematically and computationally infeasible to reconstruct any aspect of the original geometry, regardless of the reconstruction method used-deterministic, statistical, or learned.

The system guarantees irreversibility through multiple structural safeguards:
All fields are fixed in format, order, and size, with no optional or extensible elements;
No asset identifiers, memory handles, or shader references are retained;
All runtime-configurable or developer-visible structures (e.g., buffer layouts, descriptor bindings) are excluded;

This architectural design ensures that telemetry emitted by the system is safe for logging, transmission, and automated analysis in privacy-sensitive or black-box environments. Even with access to large-scale telemetry archives spanning multiple applications or time intervals, no entity can reconstruct visual content, shader logic, or rendering sequences from the emitted data.

Unlike anonymization or compression techniques, structural irreversibility prohibits logical recovery by design, not by statistical insufficiency.

The server-side logic graph performs attribution in the absence of source code, asset identifiers, or replay interfaces, enabling multi-layer classification solely from the structural summaries.

### 5. STRUCTURAL DEPARTURE FROM FIDELITY-BASED TOOLS

Conventional GPU profiling tools are designed to capture high-fidelity rendering data for purposes of replay, inspection, and developer-guided analysis. Even in reduced-capture or filtered modes, tools such as RenderDoc and NVIDIA Nsight retain asset-referential data, including vertex buffer bindings, shader references, or implicit draw sequencing.

Notably, these tools cannot be configured—through GUI toggles, scripting layers, or custom plugins—to exclude all reconstructible fields while maintaining structural determinism. No known profiler allows elimination of all memory handles, asset identifiers, or draw-state dependencies at compile time. Therefore, the structurally non-reconstructible telemetry produced by the present invention cannot be derived from, emulated by, or approximated via existing fidelity-preserving tools or runtime configurations. Such tools retain fields that, by structure and design, enable partial or full reconstruction of scene content or rendering states.

In contrast, the present invention introduces a telemetry generation model that cannot be derived from existing fidelity-preserving tools by configuration or reduction. Its compile-time abstraction and structural irreversibility represent a categorical departure from prior approaches, not an optional mode or subset of existing systems. The system produces fixed-format summaries that are specifically designed to exclude reconstructible data. All filtering logic is defined at build time, and no runtime modification or user interaction is supported.

The following table summarizes the structural distinctions between fidelity-preserving profilers and the present invention:

TABLE 1
Structural Comparison Between Fidelity-
Based Profilers and Present Invention

| | Conventional | |
|---|---|---|
| | Profilers(e.g., | Present Invention(This |
| Aspect | RenderDoc, Nsight) | disclosure) |
| Data Model | Fidelity-preserving; | Structurally abstracted; |
| | retains rendering state | fixed-format summaries |
| | and assets | only |
| Telemetry Content | Mesh indices, vertex | Triplet and metadata |
| | buffers, shaders, | summaries with no |
| | textures | content fields |
| Replay Capability | Required for frame | Not supported or present |
| | analysis | |
| Runtime | Enabled via scripts, | Disabled; logic fixed at |
| Configurability | toggles, GUIs | compile time |
| Field | Retains data for visual | Excludes all |
| Reconstructibility | recovery | reconstructible fields |
| Memory and Shader | Memory handles and | Not accessed or |
| Access | shader binaries | referenced |
| | captured | |
| Telemetry Output | Variable, runtime- | Fixed-format, compile-time |
| Format | driven | defined |
| Developer | Required for use and | Not required |
| Interaction | analysis | |
| Suitability for | Not applicable; | Fully compatible; requires |
| Black-Box | assumes internal | no source or asset access |
| Deployment | access | |

Table 1 illustrates representative architectural differences between fidelity-based profilers and the compile-time telemetry model disclosed herein. The comparison highlights the following structural departures:
Telemetry abstraction: The present system replaces asset-referential telemetry with structurally non-reconstructible summaries. For instance, traditional profilers may capture vertex arrays consisting of tens of thousands of coordinates, which—even if compressed—retain sufficient entropy for partial reconstruction or statistical inference. The present system instead emits three scalar fields per draw call, eliminating positional, relational, and visual data altogether. This abstraction does not degrade fidelity—it eliminates it entirely.
Filtering logic: Logic is statically embedded and not modifiable at runtime, eliminating configurability risks.
Output determinism: The format of emitted data is fixed, bounded, and serialization-safe.
Deployment independence: The system can operate in production, mobile, or OTA environments without developer access, replay capability, or visual inspection.

This structural divergence defines a separate telemetry architecture, which is not derivable by compression, scripting, or reduction of existing tools. By eliminating reconstructible fields and embedding all abstraction logic at compile time, the disclosed system represents a structural departure from the architecture of prior profiling tools.

It is not a reduced version, configuration subset, or alternative mode of any known fidelity-based profiler. Rather, it introduces a structurally divergent telemetry architecture, in which no fidelity-bearing field is ever generated, retained, or inferred—even under internal or debug operation.

Unlike conventional profilers which may be reconfigured to emit reduced data sets, the present system cannot be transformed—through filtering, scripting, or omission—into any fidelity-free or black-box-compatible format. The irreversibility and asset-free nature of the output are enforced structurally at compile time, and are not a byproduct of selective capture or runtime suppression.

This ensures that no subset, filtered variant, or debug configuration of existing profilers can reproduce or approximate the compile-time-defined telemetry format disclosed herein. Moreover, no known combination of runtime filters, data suppression, or post-processing can emulate or reconstitute the structurally irreducible telemetry architecture defined by the present invention.

5.1 Infeasibility of Combining Fidelity-Based Filtering with High-Compression Telemetry Under Bandwidth Constraints

While prior profiling tools rely on asset capture and replay for expert-guided performance analysis, such tools fundamentally depend on the availability of vertex data, texture content, and memory state. Without capturing these fidelity-bearing assets, the replay step fails, rendering all downstream analysis infeasible. Therefore, simple field-level filtering-such as disabling asset capture or shader tracing-does not achieve the intended diagnostic function and cannot substitute for the capture-replay-analysis paradigm.

Alternatively, one might attempt to preserve analysis capability by applying aggressive data compression—e.g., at a 100:1 or 1000:1 ratio-on captured vertex or texture content. However, even under such compression, the resulting telemetry remains variable in size and fundamentally asset-referential. For example, a single draw call with 100,000 vertices at 12 bytes per vertex still yields 1.2 megabytes of raw geometry data. Across a typical frame with 100 draw calls, this yields approximately 120 megabytes of fidelity-preserving telemetry-orders of magnitude above the 2 MB/s bandwidth constraint imposed by mobile networks, OTA vehicle diagnostics, or remote-controlled drone telemetry.

Such prior-art architectures fail to produce a compile-time bounded, asset-free, and structurally non-reconstructible telemetry stream. Their limitations are inherent: the more data is preserved for fidelity, the more bandwidth is required; the more data is removed, the less analytical value remains. No predictable combination of fidelity-based filtering and compression—however configured—can achieve the structural abstraction and bandwidth compliance demonstrated by the present invention.

Hence, the disclosed compile-time-defined, fixed-format telemetry abstraction architecture could not have been arrived at through any obvious combination of existing tools, compression techniques, or field-level suppression strategies. It departs not merely in content volume, but in structural model, data irreversibility, and deterministic boundedness.

Thus, even a skilled person familiar with fidelity-preserving tools and telemetry compression would not be motivated to construct a telemetry model that entirely omits all reconstructible fields and defers all logic to compile time, since this would eliminate their intended replay functionality.

### 6. ADVANTAGES OVER EXISTING TELEMETRY SYSTEMS

The disclosed telemetry architecture introduces the following advantages over prior fidelity-preserving systems:
Enables black-box, OTA, and privacy-sensitive deployment without asset access;
Reduces telemetry volume deterministically to fixed-length summaries (<2 MB/s total);
Eliminates the need for runtime memory allocation, scripting, or configuration;
Prevents all forms of replay, visual recovery, or behavioral inference;
Operates in logic-sealed environments with zero developer interaction;
Supports layer-specific bottleneck attribution through structural metrics.

### APPENDIX A—GLOSSARY OF STRUCTURAL TERMS

This glossary defines the key structural terms used throughout the present disclosure, including in the claims, figures, and detailed descriptions. All terms refer to static, compile-time-defined constructs used to generate and emit non-reconstructible telemetry.

### Compile-Time Filtering Engine

A fixed-function software module that performs telemetry abstraction using logic defined at system build time.

Filtering logic is generated exclusively using compile-time code templates, such as macro-generated C/C++ classes that emit only fixed telemetry fields.

No FSMs, DAGs, rule engines, or declarative configuration files (e.g., YAML or JSON) are used or supported. All logic is hardcoded at build time and embedded as non-extensible constants.

The filtering engine:
Cannot be configured or modified at runtime;
Is not scriptable or user-adjustable;
Applies the same behavior across all deployments once built.

### Configuration Subset

A profiler operating mode produced through user-selected options, GUI toggles, scripts, or parameter exclusions that reduces the telemetry volume but retains asset-reference structures, rendering state linkage, or replay capability.

### Diagnostic Triplet

A fixed-format telemetry record generated per draw call.

It comprises the following fields:
mesh count: total mesh instances rendered (unsigned 32-bit integer);
vertex count: number of vertices submitted (unsigned 32-bit integer);
topology descriptor: primitive type (enumerated 8-bit value, e.g., triangle list, line strip).

This format excludes:
mesh indices, vertex buffer content, shader inputs, and memory handles.

### Frame-Based Interval

A bounded collection of telemetry records grouped based on submission timestamp, rendering context, or graphics API frame boundary.

Frame-based intervals may correspond to swapchain presentation frames, synchronization boundaries, or software-defined render loop iterations, and are used to temporally segment telemetry data for analysis and classification purposes.

### Logic Graph

A compile-time-defined classification structure, represented as a finite state machine (FSM) or decision table, used to map telemetry-derived metrics to bottleneck layer classifications. Logic graphs are implemented in code at build time and not modifiable post-deployment.

### Runtime-Sealed Architecture

A software architecture wherein the telemetry generation logic—including field definitions, abstraction rules, and output format—is embedded at build time and cannot be altered, reconfigured, or extended after deployment.

This includes prohibiting runtime scripting, field injection, parameter redefinition, or logic graph reloading.

### Structurally Non-Reconstructible Telemetry

Telemetry that, by construction and field composition, lacks any data that could enable visual, geometric, or shader-level reconstruction of rendering activity.

This type of telemetry:
Contains no asset-identifying data, memory references, or rendering state;
Cannot be derived from any fidelity-preserving telemetry system by compression, filtering, or runtime configuration;
Excludes all fields required to reassemble geometry, shading, or texture appearance;
Is safe for storage, transmission, and automated processing without revealing scene content;
Is defined as a telemetry format for which no deterministic or probabilistic inverse mapping function exists that can reconstruct visual, structural, or behavioral aspects of the original rendering, even when aggregating telemetry across multiple frames, timelines, or data flows.
This structural irreversibility is enforced by fixed-format record definitions, field omission, and the absence of any identifiers, references, or indices that correlate with runtime state.

### Telemetry Adapter

A front-end interception module that captures structural metadata from graphics API calls.

The adapter extracts only diagnostic parameters such as vertex counts, topology types, and texture bindings, and excludes all fidelity-bearing content.

### Texture Metadata Summary

A fixed-format telemetry record generated per texture binding.

It comprises the following fields:
resolution: width and height in pixels;
format identifier: compact code for texture format (e.g., RGBA8, ASTC);
mipmap level count: number of mip levels specified;
texture type: binding target (e.g., 2D, 3D, Cubemap).

This format excludes:
pixel data, compressed texture blocks, GPU addresses, layout descriptors.

### APPENDIX B—REFERENCE TELEMETRY FORMAT SAMPLES

These examples are illustrative only and are not required to implement the invention as claimed.

The following format samples illustrate how telemetry summaries may be serialized or encoded by the system. These examples reflect the structural constraints and field exclusions defined in this disclosure. All fields are compile-time fixed, and no reconstruction-enabling data is present.

These samples are for illustrative purposes only and do not imply any required serialization standard, communication protocol, or runtime configuration interface.

### Example 1: Diagnostic Triplet (Draw Call Summary)

```
{
  “mesh_count”: 12,
  “vertex_count”: 2048,
  “topology”: “TRIANGLE_LIST”
}
```

Notes:
   No mesh indices or buffer layouts included;
   topology is an enumerated label or code, not a data block;
   Structure is fixed-length and version-safe.

### Example 2: Texture Metadata Summary (Texture Binding Summary)

```
{
  “resolution”: “1024x1024”,
  “format”: “RGBA8”,
  “mipmap_levels”: 4,
  “texture_type”: “2D”
}
```

Notes:
   No pixel data, GPU handles, or memory references;
   format uses a fixed symbolic code;
   Fields are limited to abstract binding-level metadata.

### Format Constraints

All telemetry structures generated by the system:
Are fixed-format and statically defined at compile time;
Do not contain variable-length buffers, pointers, or asset identifiers;
Are serialization-agnostic and suitable for logging, storage, or streaming;
Cannot be reversed to recover rendering behavior, geometry, or visual outputs.

1. A client-side diagnostic system for generating structurally non-reconstructible telemetry data in bandwidth-constrained black-box environments, comprising:
(a) a telemetry adapter configured to intercept graphics API calls from one or more APIs including Vulkan, OpenGL, OpenGL ES, or DirectX, and to extract structural parameters comprising vertex count, topology type, and texture binding metadata, while excluding all vertex data, index content, pixel values, shader code, and GPU memory references;
(b) a Vertex Structure Abstraction Unit (VSAU) configured to be embedded with static logic at system build time, and to transform each draw call into a fixed-format telemetry record that is structurally non-reconstructible by design, and that excludes all data fields that permit direct or indirect reconstruction of geometry, asset reference, or rendering behavior;
(c) a Texture Structure Abstraction Unit (TSAU) configured to be embedded with static logic at system build time, and to transform each texture binding operation into a fixed-format telemetry record that contains no visual, referential, or memory-correlatable data, and that renders the record inherently non-reconstructible regardless of aggregation or inference;
(d) a telemetry output formatter configured to serialize the structural summaries into compact, machine-readable, fixed-format data suitable for transmission or storage in low-bandwidth environments, and wherein the client-side system is implemented as a compile-time-defined, runtime-sealed architecture that operates continuously throughout the application lifecycle without developer interaction, configuration files, or scripting.

2. The system of claim 1, wherein each telemetry record generated by the Vertex Structure Abstraction Unit (VSAU) or Texture Structure Abstraction Unit (TSAU) conforms to a fixed-format telemetry structure comprising:
(a) a predefined field layout including only scalar values such as mesh count, vertex count, resolution, or format type;
(b) no pointers, memory handles, variable-length fields, or asset-referential data;
(c) a compile-time-defined serialization schema with fixed field order, size, and interpretation, wherein the telemetry structure excludes all fidelity-bearing fields including, without limitation, memory handles, shader references, or compressed visual data, is structurally non-reconstructible by design, and prevents any deterministic, statistical, or learned method from regenerating geometry, texture, or shading behavior from the emitted records.

3. The system of claim 2, wherein the Vertex Structure Abstraction Unit (VSAU) is configured to generate, for each draw call, a Diagnostic Triplet comprising:
(a) mesh count represented as a 32-bit unsigned integer;
(b) vertex count represented as a 32-bit unsigned integer;
(c) topology descriptor represented as an 8-bit enumerated value;
and wherein the summary is a compile-time-defined fixed-format structure that excludes any index data, vertex buffer content, GPU memory references, or shader-related metadata, and includes no variable-length fields, pointers, or dynamic schema.

4. The system of claim 2, wherein the Texture Structure Abstraction Unit (TSAU) is configured to generate, for each texture binding, a Texture Metadata Summary comprising:
(a) texture resolution in pixels (width×height);
(b) format identifier (e.g., RGBA8, ASTC);
(c) mipmap level count;
(d) texture type (e.g., 2D, 3D, cubemap);
and wherein the summary is a compile-time-defined fixed-format structure that excludes pixel data, compression blocks, GPU addresses, and asset identifiers, and includes no variable-length fields, pointers, or dynamic schema.

5. The system of claim 3, wherein the Diagnostic Triplet is implemented as a compile-time-defined fixed-format telemetry structure with fixed field order, size, and type definitions, that excludes all dynamic fields, pointer references, extensible schemas, or runtime-modifiable components, and that is serializable into formats including binary streams, JSON, or Protocol Buffers.

6. The system of claim 4, wherein the Texture Metadata Summary is implemented as a compile-time-defined fixed-format telemetry structure with fixed field order, size, and type definitions, and excludes all dynamic fields, pointer references, extensible schemas, or runtime-modifiable components, and is serializable into formats including binary streams, JSON, or Protocol Buffers.

7. A server-side diagnostic system for GPU performance bottleneck attribution, comprising:
(a) a telemetry receiver configured to receive fixed-format telemetry summaries generated by the client-side system of claim 1;
(b) a bottleneck classification engine configured, based on a compile-time-defined and runtime-nonmodifiable logic graph, to:
(i) segment the received telemetry into frame-based time intervals;
(ii) compute derived performance metrics including draw call density, vertex count variance, topology transition frequency, and GPU idle time;
(iii) classify each performance bottleneck into one of: application layer, engine layer, driver layer, or GPU hardware layer; wherein the server-side system is configured to operate entirely on the received structural summaries, perform attribution without developer input, configuration, or access to asset or shader content, and function without requiring source code, rendering assets, replay capability, or manual analysis.

8. The system of claim 7, wherein the logic graph of the bottleneck classification engine is a finite state machine or decision table defined entirely at build time and not subject to runtime rule loading, parameter adjustment, or user modification.

9. A method for GPU performance bottleneck attribution in a system comprising:
(a) a client-side diagnostic system comprising:
(i) a telemetry adapter configured to extract structural parameters from graphics API calls,
(ii) a Vertex Structure Abstraction Unit (VSAU),
(iii) a Texture Structure Abstraction Unit (TSAU), and
(iv) a telemetry output formatter for emitting fixed-format telemetry records;
(b) a server-side diagnostic system comprising:
(i) a telemetry receiver, and
(ii) a bottleneck classification engine using a compile-time-defined logic graph;
The method comprising:
(1) intercepting graphics API calls on the client device and extracting structural parameters;
(2) abstracting draw calls into Diagnostic Triplets using the VSAU;
(3) abstracting texture bindings into Texture Metadata Summaries using the TSAU;
(4) transmitting the telemetry summaries to the server over a channel not exceeding 2 megabytes per second;
(5) receiving the summaries and organizing them into frame-based intervals;
(6) classifying performance bottlenecks using a logic graph to identify a root layer selected from an application layer, an engine layer, a driver layer, or GPU hardware, wherein telemetry generation, abstraction, transmission, and classification logic is statically defined at build time and unmodifiable at runtime, and emitted telemetry records are structurally non-reconstructible through exclusion of all fidelity-bearing fields that would otherwise enable recovery of visual, geometric, or behavioral content via deterministic, statistical, or machine-learned methods, and no subset, configuration variant, or tool-generated transformation is capable of reconstructing the disclosed telemetry architecture, such that the resulting telemetry format is inherently secure for transmission, storage, and autonomous diagnostics in black-box production environments.

10. The system of claim 7, wherein the bottleneck classification engine is operable without access to rendering assets, source code, replay capability, or developer annotations, and is configured to classify performance bottlenecks across multiple architectural layers including application layer, engine layer, driver layer, and GPU hardware layer based solely on the compile-time-defined telemetry summaries.
